(19) United States
(12) Patent Application Publication
(10) Pub. No.: US 2008/0250188 A1
(43) Pub. Date: Oct. 9, 2008

(54) Memory Controller, Nonvolatile Storage, Nonvolatile Storage System, and Memory Control Method

(75) Inventors: Masahiro Nakanishi, Kyoto (JP); Tomoaki Izumi, Osaka (JP); Tetsushi Kasahara, Osaka (JP); Kazuaki Tamura, Osaka (JP); Kiminori Matsuno, Osaka (JP); Manabu Inoue, Osaka (JP); Masayuki Toyama, Osaka (JP); Kunihiro Maki, Osaka (JP)

Correspondence Address: GREENBLUM & BERNSTEIN, P.L.C., 1950 ROLAND CLARKE PLACE, RESTON, VA, 20191, US

(73) Assignee: Matsushita Electric Industrial Co., Ltd., Osaka (JP)

(21) Appl. No.: 11/722,362

(22) PCT Filed: Nov. 17, 2005
(86) PCT No.: PCT/JP05/21119

§ 371 Date: Sep. 21, 2007

(30) Foreign Application Priority Data
Dec. 22, 2004 (JP) 2004-371858

(51) Int. Cl. G06F 12/16; G06F 12/06

(52) U.S. Cl. 711/1; 711/E12.083; 711/E12.103

(57) ABSTRACT

A physical area management table (105) and a pointer table (106) are stored in a nonvolatile auxiliary storage memory (107). When a logical-physical conversion table (108) is updated (restored) in a main storage memory (140), the restored area is determined in a re-arrangement way by the pointer table to avoid rewrite concentration on the main storage memory (140). Immediately after data is written in the main storage memory (140), the state of the physical block on the physical area management table (105) is updated. Consequently, even if power interruption occurs, it is possible to reliably judge if the data is valid or not.

### TECHNICAL FIELD

The present invention relates to a nonvolatile storage device, such as a semiconductor memory card or the like, including a flash memory as a main storage memory, and a memory controller built therein, and further to a nonvolatile storage system having an access device as its component and a memory control method describing operation of the memory controller.

### BACKGROUND ART

There have been increasing demands for nonvolatile storage devices, mainly in semiconductor memory cards, provided with a rewritable nonvolatile memory. There have also been increasing demands for nonvolatile storage systems, mainly in digital still cameras and the like, using a semiconductor memory card. There are various kinds of semiconductor memory cards, and, for example, an SD memory card is composed of a flash memory as a main storage part and a memory controller for controlling it. The memory controller is a device which executes read and write control to the flash memory in accordance with read and write instructions provided from an access device such as a digital still camera main body or the like.

The flash memory has limitation that the guaranteed number of times of rewriting thereon is usually 100,000 times. Thus, in order to avoid rewriting concentrated on a particular area, a mechanism called wear leveling is employed. This mechanism prevents rewriting concentrated on a particular area by converting a logical address provided from an access device to the flash memory into a physical address, and the conversion is usually achieved based on an address management table inside the memory controller. Usually, after the address management information stored in the flash memory is read in initialization processing at power startup, the address management table is formed in a volatile memory, such as an SRAM or the like, based on the address management information.

As forms in which the address management information is stored in the flash memory, there are two major methods. The first method is a method which, when data are written on a page (sector) forming a physical block, writes management information, that is, status information indicating whether or not this data is valid and the like and a logical address into a redundant area of the top page of a physical block where the aforementioned page is included, reads the management information written in the redundant area of the top page of each block at initialization, and constructs an address management table in a volatile memory. Hereinafter, this method is called a distributed address management method.

The second method is a method which stores, for an entire memory area of the memory card or for each of areas obtained by dividing the entire memory area into a predetermined number, address management tables corresponding to this entire area collectively in predetermined blocks instead of storing the address management information in a distributed manner in units of blocks. Hereinafter, this method is called a concentrated address management method.

The present invention is premised on the concentrated address management method, and as conventional technique thereof, a technique is disclosed in Patent document 1 is known, for example.

In a device described in Patent document 1, an address management table is allocated to a fixed area of a flash memory. Since frequency of rewriting the address management tables is usually higher than the frequency of rewriting data, there has been a problem that the area to which the address management table is allocated exceeds the guaranteed number of times of rewriting in a short time, that is, a life time of an entire nonvolatile storage device shortens.

As a technique for solving this problem, for example, the technique described in Patent document 2 is known. Patent document 2 discloses the technique where data rewritten at high frequency, such as an address management table or the like, is not stored in a fixed area of a flash memory but stored in a nonvolatile memory, for example, a nonvolatile RAM such as an FeRAM (ferroelectric memory) or the like, whose guaranteed number of times of rewriting is larger than that of the flash memory. More specifically, both a logical-physical conversion table and a physical area management table as address management information are stored in the nonvolatile RAM, on that basis, rewriting processing is performed. The physical area management table is a table storing a valid flag indicating whether or not valid data is stored in a physical block and a bad block flag indicating whether or not the physical block is a bad block.
Patent Document 1: Japanese Unexamined Patent Publication No. 2001-142774
Patent Document 2: Japanese Unexamined Patent Publication No. Hei07-219720

### DISCLOSURE OF INVENTION

### Problems to be Solved by the Invention

However, Patent document 2 has following drawbacks. First, the nonvolatile RAM such as the FeRAM is very costly compared to a flash memory, an SRAM and the like, and thus largely influences the price of the memory controller. For example, assume that a memory card of 128 MBytes is realized by using one flash memory shown in table 1.

TABLE 1

| | | |
|---|---|---|
| Capacity | 128 | MBytes |
| Physical block size | 16 | kBytes |
| The number of physical | 8 | knumber |
| blocks | | |

In this case, sizes of the respective tables are as follows:

$$\begin{matrix}\begin{matrix}size of the logical \text{-} physical conversion table = 8 k \times 13 bits \\ = approximately \\ 16 kBytes ,\end{matrix} & ( 1 ) \\ \begin{matrix}size of the physical area management table = 8 k \times 2 bits \\ = 2 kBytes , and\end{matrix} & ( 2 ) \\ \begin{matrix}size of the address management table = size of the logical \text{-} physical \\ conversion table + \\ size of the physical \\ area management table \\ = 16 kBytes + 2 kBytes \\ = 18 kBytes\end{matrix} & ( 3 )\end{matrix}$$

According to the formulas (1) to (3), the size of the address management table, that is, the size of the nonvolatile RAM needs to be approximately 18 kBytes. Thus, there has arisen a problem that the memory controller becomes costly.

Further, in the nonvolatile storage device disclosed in Patent document 2, in the event of power-off during data writing, a method of judging the validity of the data, that is, a method of coping with power-off is not disclosed in detail. Thus, there is a drawback that the reliability is insufficient.

The present invention has been made to solve the abovementioned problems, and intends to provide a memory controller, a nonvolatile storage device, a nonvolatile storage system, and a memory control method capable of coping with power-off appropriately and also achieving long life without involving much cost increase.

### Means to Solve the Problems

To solve the problem, a memory controller of the present invention is a memory controller for writing and reading data to a nonvolatile main storage memory in accordance with a command and a logical address provided by an access device, wherein said memory controller comprises: a read and write control means for performing read and write control on said main storage memory; a volatile memory for temporarily storing a logical-physical conversion table read from said main storage memory; a nonvolatile auxiliary storage memory for storing a physical area management table managing status of each physical address of said main storage memory, and pointers pointing a physical address of a logical-physical conversion table stored in said main storage memory; and an address management information control means for determining, based on said logical-physical conversion table, a physical address as storage position including data in said main storage memory and for performing update of said logical-physical conversion table and pointer information, wherein said auxiliary memory is a nonvolatile memory having a larger guaranteed number of times of rewriting performed thereon than a guaranteed number of times of rewriting performed on said main storage memory, and said address management information control means, by appropriately updating by said pointer the physical address as the storage position of said logical-physical conversion table, avoids the storage position of said logical-physical conversion table from being fixed, and after data in said main storage memory is changed, sets a changed physical address of the data to be a valid status in said physical area management table.

To solve the problem, a nonvolatile storage device of the present invention is a nonvolatile storage device comprising: a nonvolatile main storage memory and a memory controller for writing and reading data to said main storage memory in accordance with a command and a logical address provided from an access device, wherein said main storage memory is a nonvolatile memory composed of a plurality of physical blocks including at least one sector respectively, wherein said memory controller comprises: a read and write control means for performing read and write control on said main storage memory; a volatile memory for temporarily storing a logical-physical conversion table read from said main storage memory; a nonvolatile auxiliary storage memory for storing a physical area management table managing status of each physical address of said main storage memory, and pointers pointing a physical address of a logical-physical conversion table stored in said main storage memory; and an address management information control means for determining, based on said logical-physical conversion table, a physical address as a storage position of data in said main storage memory and for performing update of said logical-physical conversion table and pointer information, wherein said auxiliary memory is a nonvolatile memory having a larger guaranteed number of times of rewriting performed thereon than a guaranteed number of times of rewriting performed on said main storage memory, and wherein said address management information control means, by appropriately updating by said pointer the physical address as the storage position of said logical-physical conversion table, avoids the storage position of said logical-physical conversion table from being fixed, and after the data in said main storage memory is changed, sets a written physical address of the data to be a valid status in said physical area management table.

To solve the problem, a nonvolatile storage system of the present invention is a nonvolatile storage system comprising: an access device and a nonvolatile storage device having a nonvolatile main storage memory and a memory controller, for writing and reading data to said main storage memory in accordance with a command and a logical address provided from said access device, wherein said main storage memory is a nonvolatile memory composed of a plurality of physical blocks including at least one sector respectively, wherein said memory controller comprises: a read and write control means for performing read and write control on said main storage memory; a volatile memory for temporarily storing a logical-physical conversion table read from said main storage memory; a nonvolatile auxiliary storage memory for storing a physical area management table managing status of each physical address of said main storage memory, and pointers pointing a physical address of a logical-physical conversion table stored in said main storage memory; and an address management information control means for determining, based on said logical-physical conversion table, a physical address as a storage position of data in said main storage memory and for performing update of said physical area management table and pointer information, wherein said auxiliary memory is a nonvolatile memory having a larger guaranteed number of times of rewriting performed thereon than a guaranteed number of times of rewriting performed on said main storage memory, and wherein said address management information control means, by appropriately updating by said pointer the physical address as the storage position of said logical-physical conversion table, avoids the storage position of said logical-physical conversion table from being fixed, and after the data in said main storage memory is changed, sets a changed physical address of the data to be valid status in said physical area management table.

To solve the problem, a memory control method of the present invention is a memory control method for writing and reading data to a nonvolatile main storage memory in accordance with a command and a logical address provided from outside comprising steps of: performing read and write control on said main storage memory and temporarily storing a logical-physical conversion table read from said main storage memory in a nonvolatile memory; storing, in an auxiliary storage memory being nonvolatile and having a larger number of times of rewriting performed thereon than a guaranteed number of times of rewriting performed on said main storage device, a physical area management table managing status of each physical address of said main storage memory, and pointers pointing a physical address of a logical-physical conversion table stored in said main storage memory; determining, based on said logical-physical conversion table, a physical address as a storage position of data in said main storage memory and performing update of said physical area management table and pointer information; avoiding the storage position of said logical-physical conversion table from being fixed by appropriately updating by said pointer the physical address as the storage position of said logical-physical conversion table; and setting a written physical address of the data to be a valid status in said physical area management table after the data in said main storage memory is written.

The present invention is premised on the concentrated address management method and mainly has the following characteristics.

(1) Only a physical area management table of address management tables is stored on a nonvolatile auxiliary storage memory, and a logical-physical conversion table is stored in the main storage memory and once read in the volatile memory for reference.

(2) In order that the logical-physical conversion table is not rewritten for update on a fixed area of the main storage memory, a pointer indicating the storage position thereof is stored in the nonvolatile auxiliary memory and the pointer value is sequentially updated to thereby rewrite for update the logical-physical conversion table on the main storage memory in a rearranging manner. The pointer is updated on the nonvolatile auxiliary memory having a high rewriting endurance, thus causing no problems related to the number of times of rewriting the pointer.

(3) After data is written into the main storage memory, information corresponding to the data in the physical area management table is updated. Even in the event of power-off, the validity of various data can be judged if the information is checked, thus no logical inconsistency.

### Effectiveness of the Invention

As described above, address management tables include two: a logical-physical conversion table; and a physical area management table. In the present invention, a main storage memory stores a logical-physical conversion table of a large storage demands and a nonvolatile auxiliary storage memory stores a physical area management table of a small storage demands, thus a lower-cost nonvolatile storage device can be achieved compared to the conventional technique described in Patent document 2. Moreover, the status of each data is stored on the physical area management table, so that the information is held even in the event of power-off, thus it can be possible to judge whether or not each data is valid after power is turned on again, which in turn permits an improvement of the reliability at power-off.

### BRIEF DESCRIPTION OF DRAWINGS

FIG. 1 is a block diagram showing a nonvolatile storage device according to an embodiment of the present invention.

FIG. 2 is an explanatory diagram showing a physical block according to the embodiment of the present invention.

FIG. 3 is an explanatory diagram showing a logical address format according to the embodiment of the present invention.

FIG. 4 is an explanatory diagram showing a physical management area table 105 according to the embodiment of the present invention.

FIG. 5 is an explanatory diagram showing a logical-physical conversion table 108 according to the embodiment of the present invention.

FIG. 6A is an explanatory diagram showing a pointer table 106 according to the embodiment of the present invention.

FIG. 6B is an explanatory diagram showing the pointer table 106 according to the embodiment of the present invention.

FIG. 7 is a time chart showing writing of one cluster according to the embodiment of the present invention.

FIG. 8 is a flowchart showing writing of one cluster according to the embodiment of the present invention.

### DESCRIPTION OF REFERENCE NUMERALS

100 Access device
102 CPU
105 Physical area management table
106 Pointer table
107 Auxiliary storage memory
108 Volatile memory
110 Address management information controller
112 Memory controller
113 Main storage memory

### BEST MODE FOR CARRYING OUT THE INVENTION

### Embodiment

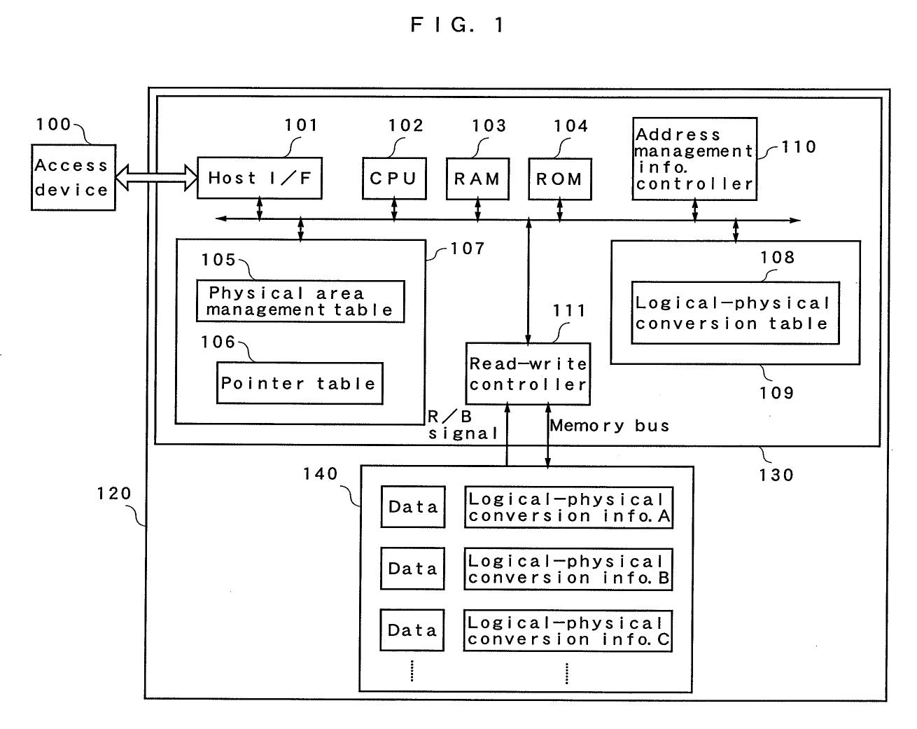

FIG. 1 is a block diagram showing a nonvolatile storage system according to an embodiment of the present invention. The nonvolatile storage system is composed of an access device 100 and a nonvolatile storage device 120. The nonvolatile storage device 120 is so formed as to include a memory controller 130 and a nonvolatile main storage memory 140. The access device 100 transfers commands for reading and writing user data (hereinafter simply referred to as data), logical addresses, and the data to the nonvolatile main storage memory 140 via the memory controller 130 of the nonvolatile storage device 120. The main storage memory 140 is composed of a plurality of physical blocks.

Next, an internal configuration of the memory controller 130 will be described. 101 denotes a host I/F, and a CPU 102 performs overall control inside the memory controller 130 with a work RAM 103 and a ROM 104 storing programs. A physical area management table 105 is a table storing information such as status of physical blocks as an erasing unit in the nonvolatile main storage memory 140, that is, whether or not valid data is stored. A pointer table 106 is a table storing pointers pointing the address of a physical block storing, of respective logical-physical conversion information stored in the nonvolatile main storage memory 140, at least the latest logical-physical conversion information. A nonvolatile auxiliary storage memory 107 stores the physical area management table 105 and the pointer table 106. A logical-physical conversion table 108 is a table which converts a logical address transferred by the access device 100 into a physical address in the nonvolatile main storage memory 140, and the logical-physical conversion table 108 is temporarily stored in a volatile memory 109 (for example, SRAM). A read and write controller 111 is a controller which performs reading and writing on the nonvolatile main storage memory 140, and the like. The nonvolatile main storage memory 140 is, for example, a flash memory, and the auxiliary storage memory 107 is a nonvolatile memory, for example, a ferroelectric memory (FeRAM) or the like.

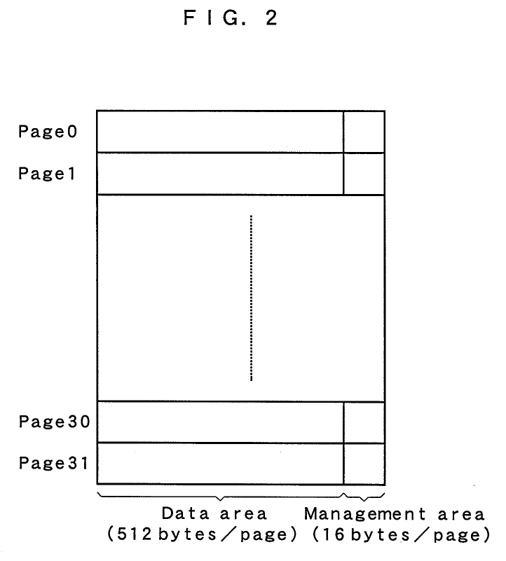

FIG. 2 is an explanatory diagram showing one physical block in the main storage memory 140 according to the embodiment of the present invention. In FIG. 2, the physical block is composed of 32 pages and each page is composed of data area of one sector and a management area. In the present embodiment, one sector is worth 512 Bytes.

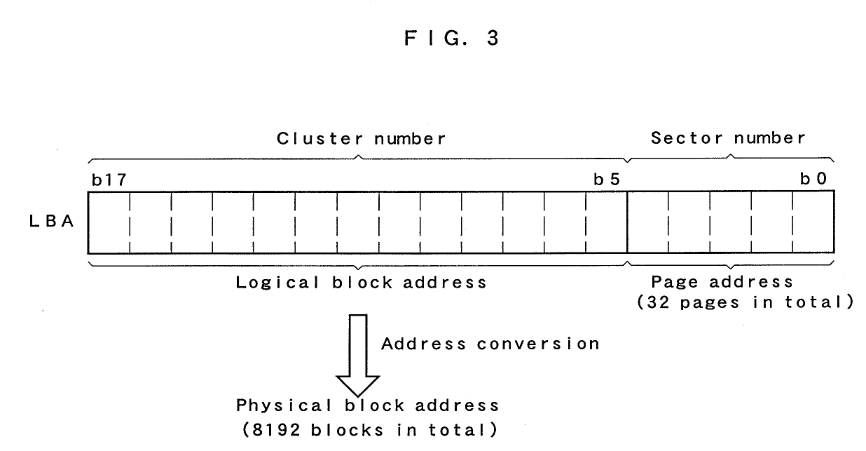

FIG. 3 is an explanatory diagram showing a format of a logical block address LBA according to the present embodiment. In FIG. 3, in order from a lower-order bit, there are a page address of 5 bits and a logical block address of 13 bits. The logical block address of 13 bits corresponds to a target of address conversion, that is, an address of the logical-physical conversion table 108. A sector size and cluster size which are defined by a file system of the access device 100 are 512 Bytes and 16 kBytes, respectively; therefore, the LSB in a cluster number corresponds to bit 5 (b5) in the logical address format.

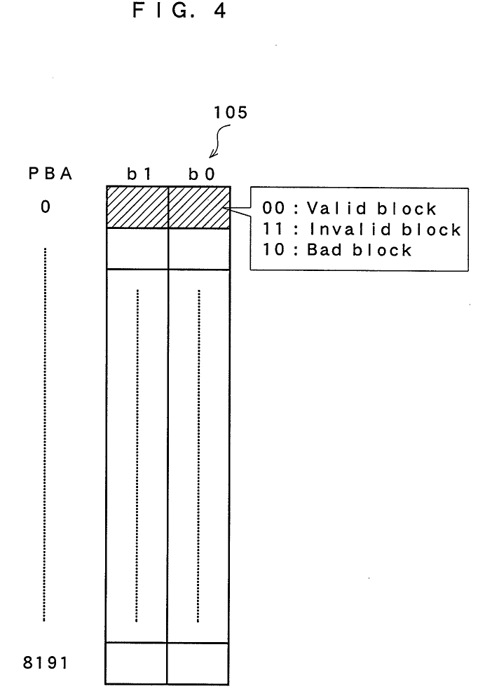

FIG. 4 is an explanatory diagram showing the physical area management table 105 according to the present embodiment. The physical area management table 105 is a table having addresses corresponding to respective physical block addresses in the nonvolatile main storage memory 140 and storing the status of each physical block with a flag of two bits. In FIG. 4, a value 00 in a binary number indicates a valid block storing valid data, a value 11 indicates an invalid block which has been already erased or which stores unnecessary data although the data is written therein, and a value 10 indicates a bad block which cannot be used any more due to a solid error or the like on a memory cell.

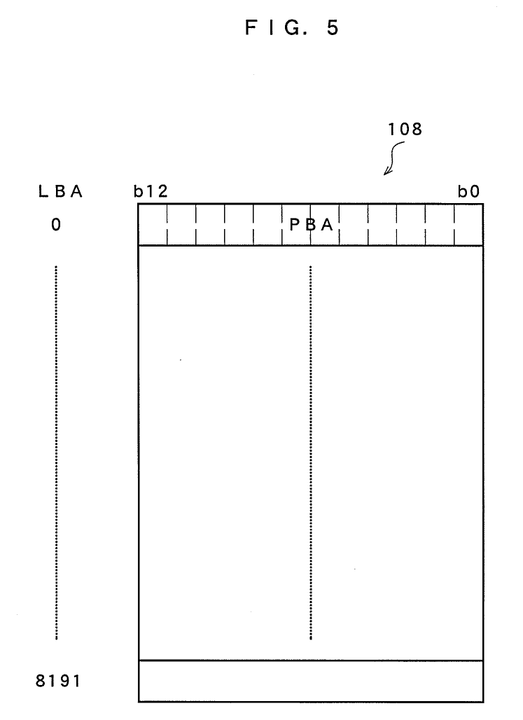

FIG. 5 is an explanatory diagram showing the logical-physical conversion table 108 in the present embodiment. In FIG. 5, an address thereof corresponds to a logical block address LSA (FIG. 3) specified by the access device 100, and the logical-physical conversion table 108 stores a physical block address PBA.

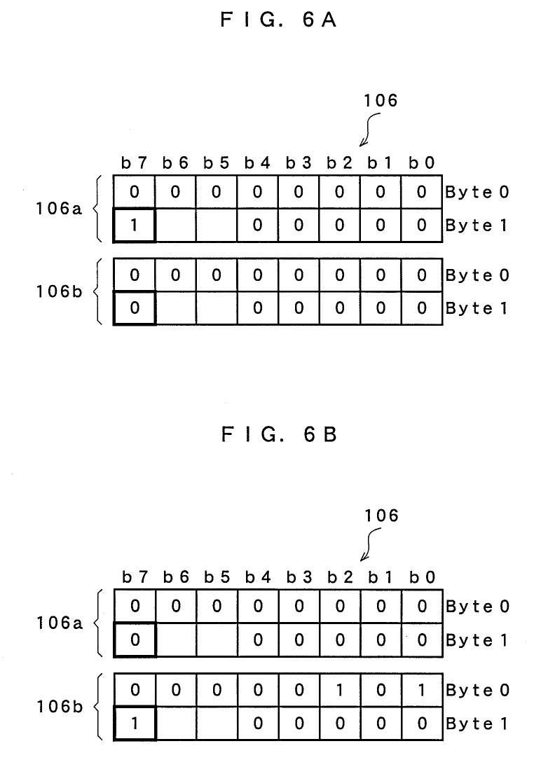

FIGS. 6A and 6B are explanatory diagrams showing the pointer table 106 in the present embodiment. For the pointer table 106, there are two kinds of pointers 106a and 106b. One of them is a pointer pointing a physical address of the latest logical-physical conversion information among the logical-physical conversion information stored in the nonvolatile main storage memory 140, and the other of them is a pointer pointing a physical address of the old logical-physical conversion information. The highest-order bit of Byte 1 indicated by a solid frame is the latest flag, and the pointer having a value 1 provided for this bit is the pointer pointing the physical address of the latest logical-physical conversion information. Each pointer has an area holding pointer values (physical address values) of 13 bits. The pointer values are stored with b4 on the Byte 1 side being defined as MSB and with bO on the Byte 0 side being defined as LSB. For example, in a case where the logical-physical conversion information is stored in the fifth block of the main storage memory 140, the pointer value is a value 5.

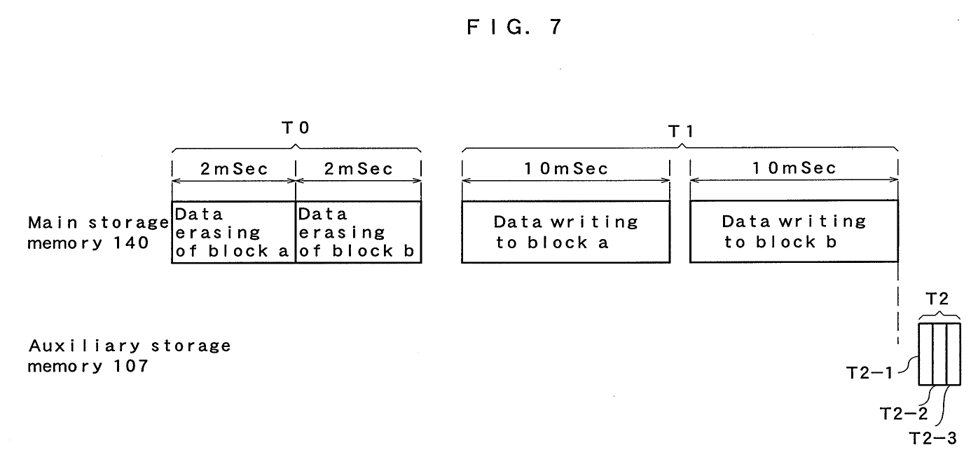

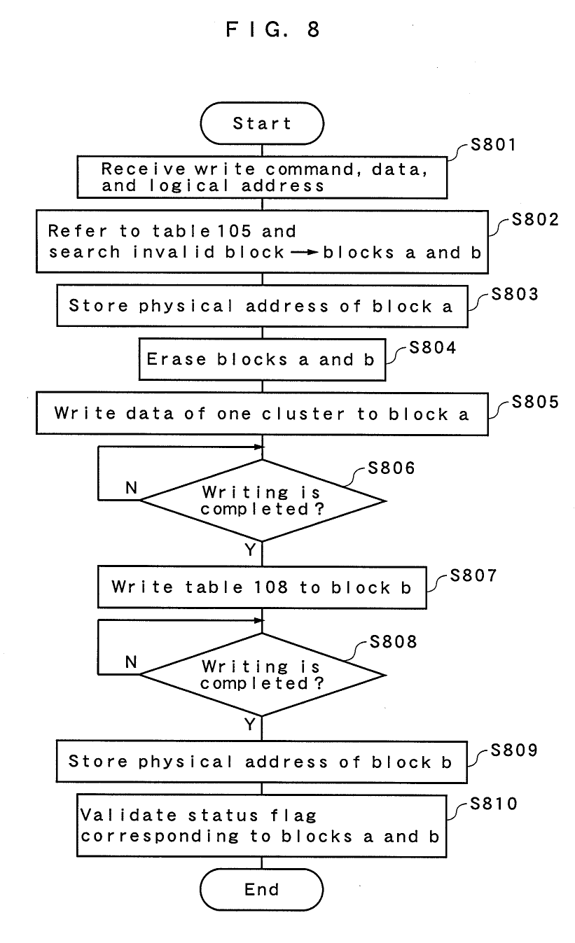

Operation of the nonvolatile storage device configured as described above will be described. FIG. 7 is a time chart showing writing of one cluster according to the present embodiment, and FIG. 8 is a flow chart thereof. First, contents of the main storage memory 140 and the various tables immediately after shipment of the nonvolatile storage device will be described. To simplify the description, the description of a system area in the main storage memory 140 will be omitted, and thus a normal area, that is, only area where the user reads and writes data will be described. Immediately after the shipment, in first use, all good blocks of the main storage memory 140 are already erased. In the physical area management table 105, good blocks are in invalid status where a value 11 in a binary number is set, and initial bad blocks are bad blocks where a value 10 in a binary number is set. Logical-physical conversion information corresponding to the logical-physical conversion table 108 is stored in the 0th physical block of the main storage memory 140. Moreover, as shown in FIG. 6A, a value 1 is set for only the latest flag and a value 0 is set for a pointer value in the pointer 106a in the pointer table 106 while values 0 are set for both the latest flag and a pointer value in the pointer 106b. If the 0th physical block of the main storage memory 140 is a bad block, the logical-physical conversion information is stored in the next 1st physical block and a value 1 is stored as the pointer value of a pointer 0.

After power is turned on, the CPU 102 performs initialization processing based on a program stored in the ROM 104. In the initialization, an address management information controller 110 refers to the pointer table 106. Then, as shown in FIG. 6A, based on the pointer having a value 1 set for the latest flag, that is, a pointer value of the pointer 106a, logical-physical conversion information stored in the 0th physical block of the main storage memory 140 is read via the read and write controller 111, and the logical-physical conversion table 108 is formed on the volatile memory 109. Thereafter, a status ready for accepting a command, such as read and write command or the like, from the access device 100 sets in. Usually, the access device 100 performs writing in units of clusters in many cases, and thus writing in units of clusters will be described hereinafter. If the access device 100 provides instructions for writing into an arbitrary logical address (FIG. 3), the CPU 102, based on the logical address value, searches for invalid blocks so that the physical blocks are used thoroughly, and after erasing the invalid block first identified as a writing target block, performs writing thereon. The search for invalid blocks may be performed in a descending order starting from the 0th block side of the physical area management table 105.

Well, the nonvolatile storage device of the present embodiment uses a nonvolatile RAM having a higher rewriting endurance and faster writing speed in small capacity than the flash memory of the main storage memory.

TABLE 2

| | | Nonvolatile memory |
|---|---|---|
| | Flash memory | RAM |
| Memory type | Nonvolatility | Nonvolatility |
| Hold duration | 10 years | 10 years |
| Data rewriting | 512 to 2 kBytes | One to several Bytes |
| unit | | |
| Write cycle | Several hundreds | 100 ns |
| | of μs | |
| Guaranteed | One hundred | Ten billion times |
| number of times | thousand times | |
| of rewriting | | |
| Overwrite | Impossible | Possible |

The nonvolatile memory RAM having the characteristics as described above can be said to be a most suitable device in terms of performance as a device for storing data which is rewritten with high frequency and which needs to be written at a high speed (for example, address management information) in a nonvolatile storage device having a flash memory or the like as a main storage memory. However, compared to the flash memory and the SRAM, the nonvolatile memory RAM is relatively costly and thus has a problem that it cannot store much data. For example, to store both the logical-physical conversion table 108 and the physical area management table 105, a cost aspect cannot be ignored. This problem becomes more notable as the storage capacity of the entire device becomes larger. Thus, in the present embodiment, in order to cope with the cost problem, data of a relatively small size, that is, the physical area management table 105 and the pointer table 106 are stored in the nonvolatile memory RAM. Under a condition that a status of each physical block is stored in 2 bits as shown in FIG. 4, the physical area management table requires 2 kB, and the pointer table requires 4 Bytes. Therefore, the capacity of the nonvolatile auxiliary storage memory 107 is 2052 Bytes. Moreover, under a condition that the physical area management table 105 stores the status of the physical blocks as only valid and invalid and collectively stores an erased or bad block as an invalid block, a capacity of one bit is sufficient. In this case, the physical management table takes 1 kB and the pointer table takes 4 Bytes. Further, in a case where the logical-physical conversion information cannot fit in one physical block, pointers also need to hold addresses of the physical blocks respectively storing the two pieces of old and new logical-physical conversion information. In this case, the old and new pointers can be provided in 8 Bytes.

Next, an address management method will be described. The nonvolatile main storage memory 140 is composed of a plurality of physical blocks. Each of the physical blocks stores data or logical-physical conversion information that is a part of address management information, and assume that, for example, the logical-physical conversion information is stored as logical-physical conversion information A, B, C, . . . as shown in FIG. 1 at a given arbitrary time. In the case where the logical-physical conversion information is assigned to one physical block in a fixed manner, a problem related to wear leveling occurs due to its high update frequency. Therefore, the logical-physical conversion information needs to be assigned in a rearranged manner, namely the storage area is not fixed, and thus they are rearranged as the logical-physical conversion information A, B, C . . . over a plurality of blocks. Of these logical-physical conversion information, the latest logical-physical conversion information is held in any one of the physical blocks and the remaining blocks hold old logical-physical conversion information. The pointer table 106 indicates which physical block stores this. The address management information controller 110 refers to the pointer table 106, checks latest flags of the pointers 106a and 106b, and recognizes, as the pointer for the physical block storing the latest logical-physical conversion information, whichever pointer has a value 1 set for the bit thereof. According to the example shown in FIG. 6B, the pointer 106b is the latest pointer, and a pointer value of the pointer 106b, that is, a 5th block becomes a physical address of the physical block storing the latest logical-physical conversion information. The pointer value of the pointer 106a, that is, the 0th block is a physical address of the physical block storing the older logical-physical conversion information immediately before the latest logical-physical conversion information. Through the read and write controller 111, the information stored in the physical block at the 5th physical address, that is, the latest logical-physical conversion information is read to the volatile memory 109 from the main storage memory 140 to form the logical-physical conversion table 108 as shown in FIG. 5.

While power is not turned off, data read and write processing is performed with constantly referring to the logical-physical conversion table 108. At each time when the logical-physical conversion table 108 is updated in accordance with data write or the like, the logical-physical conversion table 108 is written back to the nonvolatile main storage memory 140.

Next, writing back to the nonvolatile main storage memory 140 will be described. First, an invalid block is searched for based on the physical area management table 105, and after the invalid block is erased, the logical-physical conversion table 108 is written back to the main storage memory 140. The physical address (where the physical address is X) of the invalid block described above is written into the pointer of the pointer table 106, having a value 0 set for the latest flag, and a value 1 is set for this latest flag. Then, a value 0 is set for the latest flag of the other pointer. That is, the two pointers are used alternately.

Finally in the physical area management table 105, a status flag of the physical address X is updated to a value 00 in a binary number, that is, a valid block. Operation of updating the status flag in the physical area management table 105 is performed not only at processing of writing back the logical-physical conversion table 108 but also at data writing. As can be understood from the processing described above, the physical area management table 105 and the pointer table 106 are rewritten frequently, but the nonvolatile auxiliary storage memory 107 storing them is achieved by a nonvolatile memory RAM having a very high rewriting endurance as shown in table 2 and thus has no influence on a rewrite life of the entire device.

Now, a series of the write processing described above will be described referring to FIGS. 8, 7, and 1. First, in FIG. 8, when the access device 100 provides instructions for writing one cluster of data, data to be written and the logical address thereof are received (S801). The host I/F 101, in response to this, issues a write control request to the CPU 102. The CPU 102 transfers the control to the address management information controller 110, which searches for invalid blocks referring to the physical area management table 105, and determines a block “a” as a destination into which the data is written and a block “b” as a destination to which the logical-physical conversion table 108 is written back (S802). Upon the search for invalid blocks, the search is performed in such a manner that the physical blocks in the main storage memory 140 are used thoroughly. The details of this will be omitted. Then, after the physical address of the block “a” is written at a position of the corresponding logical address of the logical-physical conversion table 108 (S803), erase processing is performed to the blocks “a” and “b” (S804). Assume that the time of this erase processing is T0. Usually, it takes a time of approximately 2 msec to erase one block of the flash memory.

Next, data of one cluster is written into the block “a” (S805). Since it takes a time of approximately 300 psec to write one page of data, it takes roughly 10 msec to write one cluster, that is, data of 32 pages (FIG. 7). The address management information controller 110, based on an R/B signal (ready-busy signal) and the write size value fed back from the nonvolatile main storage memory 140 via the read and write controller 111, judges whether or not writing all the data of 32 pages has been completed (S806).

When the writing has been completed, the logical-physical conversion table 108 on the volatile memory 109 is written into the block “b” (S807). The address management information controller 110 judges whether or not write-back processing for all, that is, 32 pages of the logical-physical conversion table 108 has been completed (S808). Assume that a time of writing into the blocks “a” and “b” is T1 as shown in FIG. 7. Upon the completion, the physical address corresponding to the block “b” is written on the pointer table 106 of the auxiliary storage memory 107 (S809). Assume that the time of this writing is T2-1. Next, in the physical area management table 105, the status flags corresponding to the blocks “a” and “b ” are set in valid blocks, thereby ending the processing (S810). Assume that the times of this writing are T2-2 and T2-3, respectively. Since update of a status flag corresponding to one physical block involves rewriting of two bits, as shown in Table 2, the T2-1 to T2-3 are each as short as approximately 100 nsec (FIG. 7). In S809, the physical address corresponding to the block “b” is written into the pointer, whichever has a value 0 set for the latest flag at the time of writing, and further the value set for the latest flag of the pointer is changed to a value 1 while the value set for the latest flag of the other pointer is changed to a value 0.

Now, in FIG. 7, even when power is shut off during the times of erasing and writing on the nonvolatile main storage memory 140, that is, during the write times T0 and T1, since the status flags corresponding to the blocks “a” and “b” and the pointer table 106 have not been updated, the data written at the write time T1 and the logical-physical conversion table 108 are treated as invalid data after the next power-on, thus causing no logical consistency. In addition, even when power is shut off during the times of writing on the nonvolatile auxiliary storage memory 107 using a nonvolatile memory RAM, that is, during the write times T2-1 to T2-3, the overall time of writing on the nonvolatile auxiliary storage memory 107 is 300 nsec, which is very fast. Therefore, this permits a design for being able to complete writing within the time from when power was shut off to when operations of the CPU 102, the address management information controller 110, and the like stop, so that power shut-off has no influence. That is, there arises no problem that causes logical inconsistency, such as a problem that half-finished writing results and the value varies whenever read. In other words, the status is that either writing has or has not been surely completed, and the data written during the write time T1 and the logical-physical conversion table 108 are treated as valid in the former case and treated as invalid in the latter case.

The processing of writing one cluster of data has been described using FIGS. 8 and 7, and the same processing can be applied to processing of rewriting data of one cluster, for example. However, for the rewriting processing, a flag indicating the status of the physical block storing the old cluster data needs to be set in the invalid block. This processing may be executed immediately after S810 in FIG. 8.

The description has been given referring to an example in which a ferroelectric memory (FeRAM) is used as a nonvolatile auxiliary storage memory, but not only the FeRAM, but also a different nonvolatile RAM, such as a magnetic random access memory (MRAM), an ovonic unified memory (OUM), a resistance RAM (RRAM), or the like can be used. These nonvolatile RAMs exhibit substantially the characteristic shown in Table 2.

As described above, in the information for performing address management of the nonvolatile main storage memory 140, the logical-physical conversion information corresponding to the logical-physical conversion table 108 is stored in the main storage memory 140 achieved by a relatively low-cost flash memory, while the physical area management table 105 is stored in the auxiliary storage memory 107 achieved by a relatively high-cost nonvolatile RAM, and further approximately the pointer table 106 of several Bytes is stored in the auxiliary storage memory 107. Compared to a conventional device storing both the logical-physical conversion table 108 and the physical area management table 105 in the nonvolatile RAM, the capacity of the nonvolatile RAM can be rationalized. That is, costs of the device as a whole can be kept low.

Moreover, the address management information controller 110, based on the pointer table 106 and the physical area management table 105, performs the processing of writing the logical-physical conversion table 108 back to the nonvolatile main storage memory 140 in a rearranging manner. That is, the logical-physical conversion information is not assigned to a fixed area of the main storage memory 140, thus permitting achieving wear leveling with simple circuit configuration.

The physical area management table 105 is stored in the auxiliary storage memory 107 capable of a high-speed writing, and after the address management information controller 110 writes data and the logical-physical conversion table 108 to the nonvolatile main storage memory 140, a status flag corresponding to the physical area management table 105 is set in a valid block, thus causing no problem leading to logical inconsistency even in the event of power shut off.

### INDUSTRIAL APPLICABILITY

A nonvolatile storage device according to the present invention uses a nonvolatile memory as a main storage memory, proposes technique which achieves a low cost and a high reliability without damaging a high-speed processing performance in a device using a nonvolatile auxiliary storage memory, and is useful as a recording medium of a portable AV equipment such as a still image recording and reproduction device, a moving image recording and reproduction device, or the like, or a portable communication appliance such as a mobile phone or the like.

1. A memory controller for writing and reading data to a nonvolatile main storage memory in accordance with a command and a logical address provided by an access device, wherein
said memory controller comprises:
a read and write control means for performing read and write control on said main storage memory;
a volatile memory for temporarily storing a logical-physical conversion table read from said main storage memory;
a nonvolatile auxiliary storage memory for storing a physical area management table managing status of each physical address of said main storage memory, and pointers pointing a physical address of a logical-physical conversion table stored in said main storage memory; and
an address management information control means for determining, based on said logical-physical conversion table, a physical address as storage position including data in said main storage memory and for performing update of said logical-physical conversion table and pointer information, wherein
said auxiliary memory is a nonvolatile memory having a larger guaranteed number of times of rewriting performed thereon than a guaranteed number of times of rewriting performed on said main storage memory, and
said address management information control means, by appropriately updating by said pointer the physical address as the storage position of said logical-physical conversion table, avoids the storage position of said logical-physical conversion table from being fixed, and after data in said main storage memory is changed, sets a changed physical address of the data to be a valid status in said physical area management table.

2. The memory controller according to claim 1, wherein
said auxiliary storage memory is a memory having a faster writing speed than that of said main storage memory.

3. The memory controller according to claim 2, wherein
said auxiliary storage memory is a nonvolatile RAM.

4. The memory controller according to claim 1, wherein
the pointer held in said auxiliary storage memory includes two sets of pointers indicating a physical address of a latest logical-physical conversion table stored in the main storage memory and a physical address of a physical area management table immediately therebefore stored in the main storage memory.

5. The memory controller according to claim 3, wherein
said auxiliary storage memory is any one of a ferroelectric memory (FeRAM), a magnetic random access memory (MRAM), an ovonic unified memory (OUM), and a resistance RAM (RRAM).

6. A nonvolatile storage device comprising:
a nonvolatile main storage memory and a memory controller for writing and reading data to said main storage memory in accordance with a command and a logical address provided from an access device, wherein
said main storage memory is a nonvolatile memory composed of a plurality of physical blocks including at least one sector respectively, wherein
said memory controller comprises:
a read and write control means for performing read and write control on said main storage memory;
a volatile memory for temporarily storing a logical-physical conversion table read from said main storage memory;
a nonvolatile auxiliary storage memory for storing a physical area management table managing status of each physical address of said main storage memory, and pointers pointing a physical address of a logical-physical conversion table stored in said main storage memory; and
an address management information control means for determining, based on said logical-physical conversion table, a physical address as a storage position of data in said main storage memory and for performing update of said logical-physical conversion table and pointer information, wherein
said auxiliary memory is a nonvolatile memory having a larger guaranteed number of times of rewriting performed thereon than a guaranteed number of times of rewriting performed on said main storage memory, and wherein
said address management information control means, by appropriately updating by said pointer the physical address as the storage position of said logical-physical conversion table, avoids the storage position of said logical-physical conversion table from being fixed, and after the data in said main storage memory is changed, sets a written physical address of the data to be a valid status in said physical area management table.

7. The nonvolatile storage device according to claim 6, wherein
said auxiliary storage memory is a memory having a faster writing speed than that of said main storage memory.

8. The nonvolatile storage device according to claim 7, wherein
said auxiliary storage memory is a nonvolatile RAM.

9. The nonvolatile storage device according to claim 6, wherein
the pointer held in said auxiliary storage memory includes two sets of pointers indicating a physical address of a latest logical-physical conversion table stored in the main storage memory and a physical address of a physical area management conversion table immediately therebefore stored in the main storage memory.

10. The nonvolatile storage device according to claim 8, wherein
said auxiliary storage memory is any one of a ferroelectric memory (FeRAM), a magnetic random access memory (MRAM), an ovonic unified memory (OUM), and a resistance RAM (RRAM).

11. A nonvolatile storage system comprising:
an access device and a nonvolatile storage device having a nonvolatile main storage memory and a memory controller, for writing and reading data to said main storage memory in accordance with a command and a logical address provided from said access device, wherein
said main storage memory is a nonvolatile memory composed of a plurality of physical blocks including at least one sector respectively, wherein
said memory controller comprises:
a read and write control means for performing read and write control on said main storage memory;
a volatile memory for temporarily storing a logical-physical conversion table read from said main storage memory;
a nonvolatile auxiliary storage memory for storing a physical area management table managing status of each physical address of said main storage memory, and pointers pointing a physical address of a logical-physical conversion table stored in said main storage memory; and
an address management information control means for determining, based on said logical-physical conversion table, a physical address as a storage position of data in said main storage memory and for performing update of said physical area management table and pointer information, wherein
said auxiliary memory is a nonvolatile memory having a larger guaranteed number of times of rewriting performed thereon than a guaranteed number of times of rewriting performed on said main storage memory, and wherein
said address management information control means, by appropriately updating by said pointer the physical address as the storage position of said logical-physical conversion table, avoids the storage position of said logical-physical conversion table from being fixed, and after the data in said main storage memory is changed, sets a changed physical address of the data to be valid status in said physical area management table.

12. The nonvolatile storage system according to claim 11, wherein
said auxiliary storage memory is a memory having a faster writing speed than that of said main storage memory.

13. The nonvolatile storage system according to claim 12, wherein
said auxiliary storage memory is a nonvolatile RAM.

14. The nonvolatile storage system according to claim 11, wherein
the pointer held in said auxiliary storage memory includes two sets of pointers indicating a physical address of a latest logical-physical conversion table stored in the main storage memory and a physical address of a physical area management table immediately therebefore stored in the main storage memory.

15. The nonvolatile storage system according to claim 11, wherein
said auxiliary storage memory is any one of a ferroelectric memory (FeRAM), a magnetic random access memory (MRAM), an ovonic unified memory (OUM), and a resistance RAM (RRAM).

16. A memory control method for writing and reading data to a nonvolatile main storage memory in accordance with a command and a logical address provided from outside comprising steps of:
performing read and write control on said main storage memory and temporarily storing a logical-physical conversion table read from said main storage memory in a nonvolatile memory;
storing, in an auxiliary storage memory being nonvolatile and having a larger number of times of rewriting performed thereon than a guaranteed number of times of rewriting performed on said main storage device, a physical area management table managing status of each physical address of said main storage memory, and pointers pointing a physical address of a logical-physical conversion table stored in said main storage memory;
determining, based on said logical-physical conversion table, a physical address as a storage position of data in said main storage memory and performing update of said physical area management table and pointer information;
avoiding the storage position of said logical-physical conversion table from being fixed by appropriately updating by said pointer the physical address as the storage position of said logical-physical conversion table; and
setting a written physical address of the data to be a valid status in said physical area management table after the data in said main storage memory is written.

17. The memory control method according to claim 16, wherein
said auxiliary storage memory is a memory having a faster writing speed than that of said main storage memory.

18. The memory control method according to claim 17, wherein
said auxiliary storage memory is a nonvolatile RAM.

19. The memory control method according to claim 16, wherein
the pointer held in said auxiliary storage memory includes two sets of pointers indicating a physical address of a latest logical-physical conversion table stored in the main storage memory and a physical address of a physical area management table immediately therebefore stored in the main storage memory.
